(19) United States
(12) Patent Application Publication
(10) Pub. No.: US 2008/0119123 A1
(43) Pub. Date: May 22, 2008

(54) FUEL FILLER PIPE HAVING TRIGGER POINT

(75) Inventors: Marwan Elbkaily, Canton, MI (US); Balachandra Deshpande, Novi, MI (US)

Correspondence Address: Thomas Moga;Butzel Long, STONERIDGE WEST, 41000 WOODWARD AVENUE, BLOOMFIELD HILLS, MI, 48304, US

(73) Assignees: FORD MOTOR COMPANY, Dearborn, MI (US); FORD GLOBAL TECHNOLOGIES, LLC, Dearborn, MI (US)

(21) Appl. No.: 11/558,548

(22) Filed: Nov. 10, 2006

(51) Int. Cl. B23F 21/00

(52) U.S. Cl. 451/541

(57) ABSTRACT

A fuel filler pipe having a trigger point formed between the fuel supply port and the fuel tank. The trigger point is a trough-like depression which, if there is a structural disruption of the vehicle, will facilitate a buckling mode in the pipe and consequent energy absorption. This configuration reduces or eliminates the amount of displacement of the fuel filler pipe into the fuel tank during such structural disruption of the vehicle.

### TECHNICAL FIELD

The present invention relates generally to vehicle fuel systems. More specifically, the present invention relates to a fuel pipe having a trigger point which allows the fuel pipe to buckle if there is a structural disruption of the vehicle, thus reducing or entirely eliminating the amount of displacement of the fuel filler pipe into the fuel tank during the structural disruption.

### BACKGROUND OF THE INVENTION

In the modern motor vehicle fuel is delivered to the fuel tank by a fuel filler pipe. The fuel filler pipe creates a fluid connection between the fuel supply port disposed within the fuel filler housing and the fuel tank. Fuel filler pipes are made of a metal or a synthetic resin. Those fuel filler pipes composed of metal are typically composed of stainless steel, aluminum, or steel.

Fuel systems in motor vehicles, including the fuel filler pipe, must meet certain safety standards. In seeking to surpass known standards, motor vehicle manufacturers attempt to improve the integrity of their vehicle fuel system designs. One sought-after improvement has to do with the fuel filler pipe of the fuel system and how it reacts in the event of a structural disruption of the vehicle. Accordingly, as in so many areas of motor vehicle technology, there is room in the art of motor vehicle fuel systems for providing an alternative configuration to known fuel filler pipe designs.

### SUMMARY OF THE INVENTION

The present invention provides an alternative configuration for a fuel filler pipe which includes an area of reduced cross-section relative to the rest of the fuel filler pipe which defines a crumple area or a trigger point in the fuel filler pipe. The trigger point formed in an appropriate location facilitates a buckling mode in the pipe in the event that there is a structural disruption of the vehicle and consequent energy absorption. By providing the trigger point in an appropriate place in the fuel filler pipe, during such a disruption the amount of possible displacement or intrusion of the pipe into the fuel tank is reduced or eliminated.

With the trigger point provided at an appropriate location on the fuel filler pipe with an appropriate geometry, an alternative construction of the current fuel filler pipe is provided.

Other advantages and features of the invention will become apparent when viewed in light of the detailed description of the preferred embodiment when taken in conjunction with the attached drawings and the appended claims.

### BRIEF DESCRIPTION OF THE DRAWINGS

For a more complete understanding of this invention, reference should now be made to the embodiment illustrated in greater detail in the accompanying drawings and described below by way of examples of the invention wherein:

FIG. 1 shows an elevation view of a fuel filler pipe in relation to a fuel tank, partially broken away, according to the prior art;

FIG. 2 shows an elevation view of a fuel filler pipe in relation to a fuel tank, partially broken away, according to the present invention;

FIG. 3 shows a close-up view of the trigger point of the fuel pipe of the present invention;

FIG. 4 is a cross section of the trigger point of the fuel filler pipe according to the present invention taken along lines 4-4 of FIG. 3; and

FIG. 5 shows the fuel filler pipe and fuel tank of FIG. 2 after a structural disruption of the vehicle with the filler pipe in a buckled condition.

### DETAILED DESCRIPTION OF THE PREFERRED EMBODIMENT

In the following figures, the same reference numerals will be used to refer to the same components. In the following description, various operating parameters and components are described for one constructed embodiment. These specific parameters and components are included as examples and are not meant to be limiting.

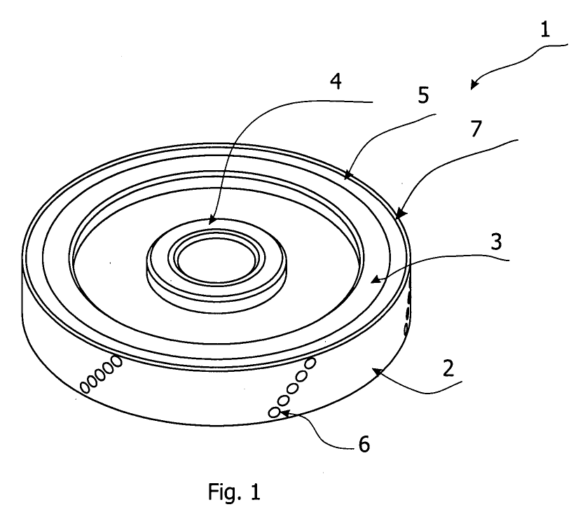

With reference to FIG. 1, a fuel delivery assembly according to known technology, generally illustrated as 10. The fuel delivery assembly 10 includes a fuel tank 12, a fuel filler port 14, and a fuel filler pipe 16 connected to a fuel tank inlet pipe 18. An air vent tube 20 is provided in fluid relation to the fuel filler port 14. As is known in the art, the fuel filler pipe 16 is of a constant diameter between the fuel filler port 14 and the fuel tank pipe 18.

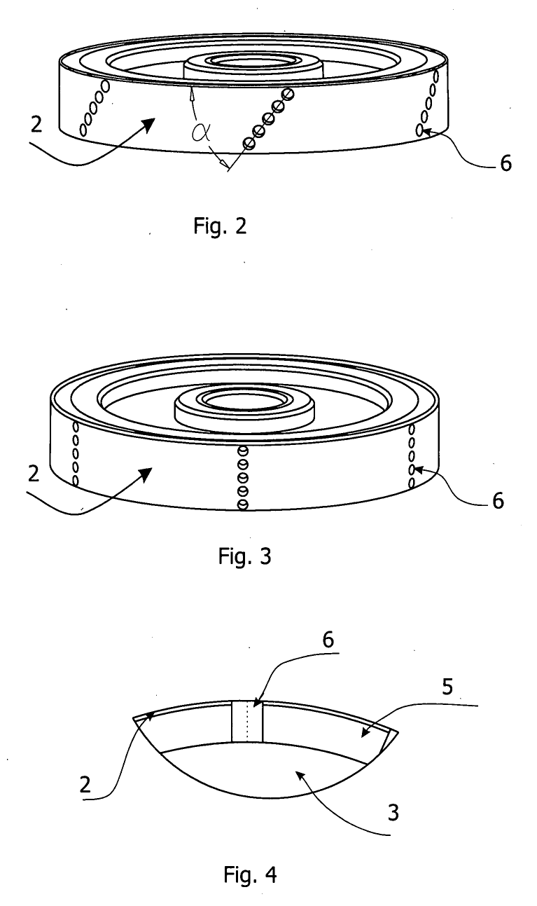

With reference to FIGS. 2 through 4, a fuel delivery assembly according to the present invention, generally illustrated as 30, is shown. The fuel delivery assembly 30 includes a fuel tank 32, a fuel filler port 34, and a fuel filler pipe 36 connected to a fuel tank inlet pipe 38. In addition, an air vent tube 40 is provided in fluid relation to the fuel filler port 34 as is conventionally provided.

The diameter of the fuel filler pipe 36 from its inlet end at the fuel filler port 34 to its outlet end at the fuel tank inlet pipe 38 is relatively constant with the exception of an area of reduced cross-section which defines a crumple area or a trigger point 42 which is located on a bend of the fuel filler pipe 36. The trigger point 42 defines a trough-like depression and may be formed by any one of several known methods, including formation by a punch or by stamping. The thickness of the wall of the fuel filler pipe 36 at the trigger point 42 may be the same as the thickness of the other areas of the wall of the fuel filler pipe 36 or may be of reduced thickness to allow for more effective buckling if there is a structural disruption of the vehicle.

The trigger point 42 is preferably formed at the bend of the fuel filler pipe 36 as illustrated to increase the tendency of this area to form a plastic hinge upon loading.

Correct placement and geometry of the trigger point 42 relative to the fuel filler pipe 36 are factors that need to be carefully considered. As illustrated particularly in FIG. 2, the trigger point 42 is disposed at the bent area of the fuel filler pipe 36 that is formed roughly half-way between the fuel filler port 34 and the fuel tank inlet pipe 38. According to such placement, if there is a structural disruption of the vehicle the trigger point 42 facilitates a buckling mode and consequently absorbs energy that would otherwise cause displacement or intrusion of the fuel tank inlet pipe 38 into the fuel tank 32.

While the trigger point 42 is illustrated as being at the approximate mid-point of the fuel filler pipe 36 between the fuel filler port 34 and the fuel tank inlet pipe 38, the trigger point 42 may be formed at an alternative point on the fuel filler pipe 36 or there may be two or more trigger points fitted on the fuel filler pipe 36.

A cross-sectional view of the fuel filler pipe 36 at the trigger point 42 is illustrated in FIG. 4. A certain percentage of the circumference of the filler pipe 36 is encompassed by the trigger point 42. As illustrated, about 20 percent of the circumference of the filler pipe 36 is encompassed by the trigger point 42. However, it is to be understood that a greater or lesser percentage of the circumference of the filler pipe 36 may be encompassed by the trigger point 42 without deviating from the scope of the present invention. Preferably the trigger point 42 will encompass between about 10 and 30 percent of the circumference of the filler pipe 36. In any event, it is preferable that the trigger point 42 not be axisymmetric to avoid the backflow of fuel which might otherwise result.

The possible result of a structural disruption of the vehicle is illustrated in FIG. 5 where the impact force has been transmitted to the trigger point 42 which has absorbed the energy from the impact force that caused the structural disruption of the vehicle and has allowed a slight angular deformation or buckling of the fuel filler pipe 36 at the trigger point 42. Intrusion of the fuel tank inlet pipe 38 has thus been avoided and, in addition, no rupturing of the connection between the fuel tank inlet pipe 38 and the fuel tank 32 has occurred, virtually eliminating the possibility of fuel spillage.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

1. A fuel filler pipe for a motor vehicle which is provided between a fuel tank and a fuel supply port, the fuel filler pipe comprising:
a fuel filler body having a fuel tank end and a fuel supply port end, said fuel filler body having a first diameter; and
a trigger point formed on said fuel filler body between said fuel tank end and said fuel supply port end, said trigger point having a second diameter, said second diameter being less than said first diameter, whereby said trigger point allows for buckling of said fuel filler body if one of said fuel tank end or said fuel supply port end is displaced with respect to the other of said fuel tank end or said fuel supply port end.

2. The fuel filler pipe of claim 1 wherein said trigger point is defined by a trough-like depression formed in said fuel filler body.

3. The fuel filler pipe of claim 1 wherein said fuel filler body has a bend formed therein between said fuel tank end and said fuel supply port end and said trigger point is formed on said bend.

4. The fuel filler pipe of claim 3 wherein said trigger point is defined by a trough-like depression formed on said bend.

5. The fuel filler pipe of claim 1 wherein said second diameter is between about 70 and 90 percent of the first diameter.

6. The fuel filler pipe of claim 1 wherein said second diameter is about 80 percent of said diameter.

7. A fuel filler pipe for a motor vehicle which is provided between a fuel tank and a fuel supply port, the fuel filler pipe comprising:
a fuel filler body having a diameter and having a fuel tank end and a fuel supply port end, said fuel filler body having a bend formed between said fuel tank end and said bend, said trigger point having a diameter, said diameter of said trigger point being different from said diameter of said fuel filler body.

8. The fuel filler pipe of claim 7 wherein said diameter of said trigger point is less than said diameter of said fuel filler body.

9. The fuel filler pipe of claim 7 wherein said trigger point is defined by a trough-like depression formed in said fuel filler body.

10. The fuel filler pipe of claim 7 wherein said diameter of said trigger point is between about 70 and 90 percent of the diameter of said fuel filler body.

11. The fuel filler pipe of claim 7 wherein said diameter of said trigger point is about 80 percent of the diameter of said fuel filler body.

12. A fuel filler body having a diameter and having a fuel tank end and a fuel supply port end, said fuel filler body further including a trigger point, said trigger point having a diameter, said diameter of said trigger point being different from said diameter of said fuel filler body.

13. The fuel filler of claim 12 wherein said fuel filler body has a diameter and said trigger point has a diameter, said diameter of said fuel filler body being different from said diameter of said trigger point.

14. The fuel filler pipe of claim 13 wherein said diameter of said trigger point is less than said diameter of said fuel filler body.

15. The fuel filler pipe of claim 12 wherein said trigger point is defined by a trough-like depression formed in said fuel filler body.

16. The fuel filler pipe of claim 12 wherein said fuel filler body has a bend formed between said fuel tank end and said fuel supply port end, said trigger point being formed at said bend.

17. The fuel filler pipe of claim 12 wherein said diameter of said trigger point is between about 70 and 90 percent of the diameter of said fuel filler body.

18. The fuel filler pipe of claim 12 wherein said diameter of said trigger point is about 80 percent of the diameter of said fuel filler body.
